(19) United States
(12) Patent Application Publication
(10) Pub. No.: US 2002/0165746 A1
(43) Pub. Date: Nov. 7, 2002

(54) Computerized or computerizable process for planning logistical operations

(75) Inventor: Gerard Lieutet, Paris (FR)

Correspondence Address: SCHNADER HARRISON SEGAL & LEWIS, LLP, 1600 MARKET STREET, SUITE 3600, PHILADELPHIA, PA, 19103

(73) Assignee: Gerard Lieutet, Paris (FR)

(21) Appl. No.: 10/138,200

(22) Filed: May 3, 2002

Related U.S. Application Data
(63) Continuation of application No. PCT/FR00/02990, filed on Oct. 26, 2000.

(30) Foreign Application Priority Data
Nov. 5, 1999 (FR) FR 99/13927

(51) Int. Cl. G06F 17/60

(52) U.S. Cl. 705/7

(57) ABSTRACT

A computerized or computerizable process for planning logistical operations, including a) forming a companies database including a multiplicity of information files descriptive of a profile of selected interveners, the information files including an identifier and a list of usual destinations of an environment considered, the companies database being stored in a memory of a server center, b) establishing with a calculator of the server center an operations definitions file in response to a request from a requester registered in a requesters database, c) transmitting by the server center, for each operation defined in steps a) and b), a definition file of operation parameters including a form for determining the nature and specificities of the operation, and defining at least one actor for each operation, d) defining and updating an operating sequence by the server center from information transmitted during steps a)-c), and e) activating the operating sequence with a triggering event and testing conformity of the triggering event with the operating sequence.

### RELATED APPLICATION

This is a continuation of International Application No. PCT/FR00/02990, with an international filing date of Oct. 26, 2000, which is based on French Patent Application No. FR 99/13927, filed Nov. 5, 1999.

### FIELD OF THE INVENTION

This invention concerns the field of logistics and, more precisely, equipment and processes for preparing, executing information flow management, monitoring and logistical operations information.

### BACKGROUND

Various solutions for automating logistical operations are known in the state of the art. For example, DE 19721772 describes a logistics control and verification system and EP 425405 describes an automatic method for booking and confirming a client's order.

Also known is U.S. Pat. No. 5,596,502 which describes a planning system using an adaptive computerized system controlled by a request. This system is called the “Cube system” and uses a “CUBEBOOKING” program operating in real time for loading tasks (a predefined processing system) in cells called “Cubecells” at the level of a work system in the time defined in the “Cubeworld” selected in response to a request entered in this “Cubeworld” by a client's order.

The program allocates the best available resources for producing the products (Product Resources) constituted of material (Material Resources on a Positive Materials List) having certain characteristics (contained in a Negative Materials List). The Cube System is designed to ensure monitoring other possible processing paths for compatibilization systems and conserves historic resource production and use models in the form of primary data for resolving conflicts among the limited capacity resources (Resource Conflicts).

The program “CUBEVIEW” produces three-dimensional representations of a Request for and Provision of Available Resources (shown on the z axis) at the level of work spaces (shown on the y axis) in time (shown on the x axis) by a series of “Cube Views” and displays the resource conflicts whose presence requires intervention by the user which is given shape by rotating the cubic display such that the z, y axes can be examined (Resources, z, on the horizontal axis; work spaces, y, also on the vertical axis at the moment=0, a given time cell) for conflicts. Using the View, the system recommends other possible assignment of the resources to other work spaces to eliminate the resource conflicts in the various Cube Cells.

This solution is valid for internal use. It does not allow optimization of the needs of a multiplicity of requesters.

It would accordingly be advantageous to provide a process and equipment for optimizing the processes forming the operating sequences and preparing sequences whose execution is triggered by the final user and not by the issuer. It would be particularly advantageous to improve the inventory control and production of the different phases that are most involved in supplying a product, either by a production or assembly line, or by consumption by the final client. It would still further be advantageous to provide access to an information system common to multiple users and to share requests for better use of the resources.

### SUMMARY OF THE INVENTION

This invention relates to a computerized or computerizable process for planning logistical operations, including a) forming a companies database including a multiplicity of information files descriptive of a profile of selected interveners, the information files including an identifier and a list of usual destinations of an environment considered, the companies database being stored in a memory of a server center, b) establishing with a calculator of the server center an operations definitions file in response to a request from a requester registered in a requesters database, c) transmitting by the server center, for each operation defined in steps a) and b), a definition file of operation parameters including a form for determining the nature and specificities of the operation, and defining at least one actor for each operation, d) defining and updating an operating sequence by the server center from information transmitted during steps a)-c), and e) activating the operating sequence with a triggering event and testing conformity of the triggering event with the operating sequence.

### BRIEF DESCRIPTION OF THE DRAWINGS

Better comprehension of the invention will be obtained from the description below with reference to a nonlimitative example of implementation and to the attached figures in which:

FIG. 1 is a schematic view of an information system according to aspects of the invention,

FIG. 2 is a schematic representation of the process according to aspects of the invention,

FIG. 3 is a schematic view of a flow of data and information among various components of a planning system according to aspects of the invention,

FIG. 4 is a combination diagram,

FIG. 5 is a sharing algorithm,

FIG. 6 is a distribution diagram,

FIG. 7 is a flow diagram for two sequences with the transports, respectively, of D1 to C1 and D2 to C2,

FIG. 8 is an algorithm for grouping together two sequences,

FIG. 9 is an algorithm for “round-trip” grouping together, and

FIG. 10 is an algorithm for “on the same path” grouping together.

### DETAILED DESCRIPTION

The invention concerns in its broadest sense a computerized or computerizable process for planning logistical operations, comprising:

a step of constituting a “requesters” database comprising a multiplicity of information files descriptive of the profile of each requester, this information comprising, in particular, an identifier and a list of the usual destinations of each requester considered, said “requesters” database being stored in a memory of a server center,

a step of establishing by means of the calculator of the server center of an “operations definitions” file in response to a request from a requester registered in the “requesters” database,

a step of transmitting by the server center, for each operation defined in the preceding step, of a definition file of the operation parameters comprising a form for determination of the nature and specificities of the operation, and definition of at least one actor of the operation,

a step of definition of the operating sequence by the server center, this step consisting of calculating from the information transmitted during the preceding steps of a definition file of the nature and chronology of the operations, and

a step of activation of the operating sequence by a triggering event and an operation of testing the conformity of the triggering event with the operating sequence.

According to a preferred variant, the process according to the invention comprises a step of combining a multiplicity of operating sequences by the grouping together of operations whose time-related and geographic information are identical or nearly identical. The requester is the implementer of the process which collects the information.

Furthermore, the process advantageously comprises a step of preparation of a library of solutions recorded by the server center, with the data stored in this library being exploited during the steps of establishing the definitions of the operations.

The process according to the invention enables improvement in the structuring of the logistical and information flows, optimization of the material and product flows, and equilibration of the loads and capacities of the resources by dividing the logistical link into operating sequences. It also makes possible the traceability of products and processes and the phasing of elapsed times and means.

In the description below, the term “final client” is used to designate the initiator of a request for an article or good, for example, an assembly line or a final user. The term “requester” designates the manufacturer or supplier (the implementer of the logistical process). The invention allows the requester to process its logistics in a dynamic manner. The term “operating sequence” designates the set of information required for coordinating and implementing the actors and the means required for a logistical operation, for time management and the dynamic allocation of the resources as well as for monitoring the steps of the logistical operation.

In the process according to the invention, expression of a request is made by a final client which drives the orientation of flows in the “supplier-to-client” direction. The different operations are arranged by inverted chronological dates to always take into account the date of its execution. The invention as described below envisages respecting the constraints of each intervener. These interveners can be numerous: suppliers, packaging suppliers, customs formalities, shipping, transport, receiving and, of course, the final client, issuer of the request.

For each of these interveners, it is possible to allocate the management parameters. Logistics comprises managing the flows of information controlling the physical phases of the material flow in relation to the management parameters of each of the interveners, and of constructing an operating sequence after having listed the various phases of an operation and having performed the organizing of these phases.

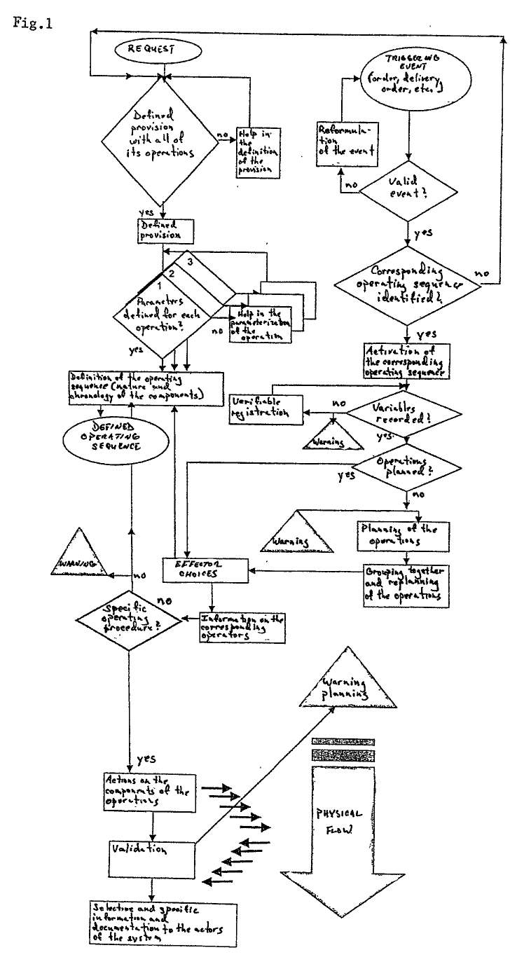

FIG. 1 shows a schematic view of the information system.

The successive steps of the logistics comprise:

a phase of determining the environment and role of the various interveners in the constituted logistics chain,

a phase of taking into account the different parameters of the final clients in relation to the means that it is desired to employ, and the client's specifications, from a library of hypotheses (checklist of the constraints to take into account in the domain in question) making it possible to guide and protect the input of the information,

a phase of analysis and investigating the most appropriate solution in relation to the desired means and the specifications of the final client,

planning,

monitoring the operations and information of the operators, and

activation of the operating sequence and procedures to be applied in each affected domain upon the integration of a new request.

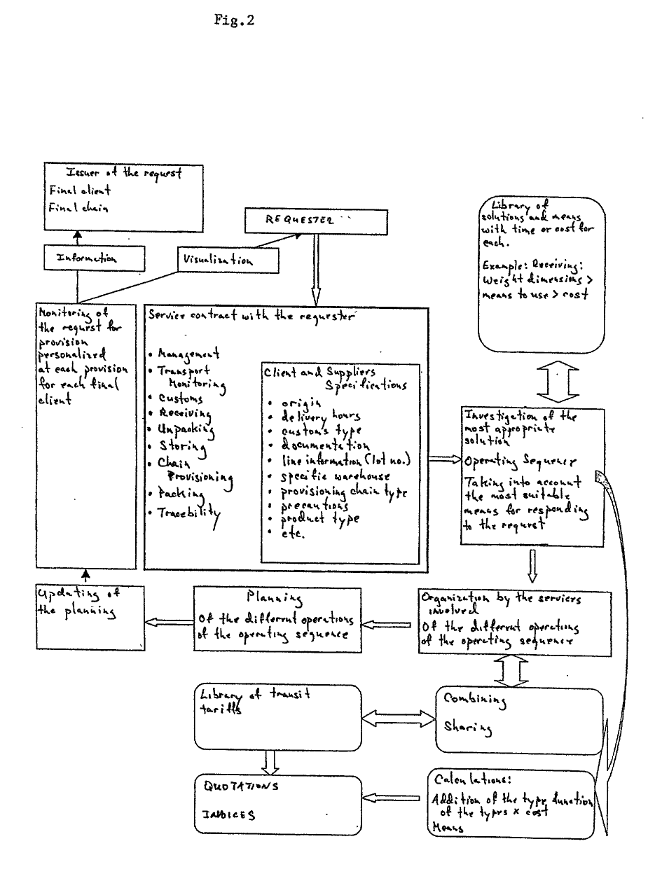

The operation of the invention is described with reference to FIG. 2.

The data processing architecture of the invention comprises a multiplicity of terminals connected by a specific network or the Internet to a server center exploited by the manager of the process. Each of the requesters is defined with its environment and its position in relation to the other interveners in a database in which are recorded various information such as:

the requester's identifier,

the requester's coordinates,

the coordinates of the set of interveners with their role,

billing information, and

information regarding the requester's usual destination addresses and operators.

In order to construct an operating sequence, the requester desiring to take charge of the set of tasks (for its own account if it is a manufacturer, for the account of another party if the requester is a service allocator-provider) upstream or downstream of the production connects to the server center for preparation of the operation definition files. These files are constituted by forms whose models are stored in a database of the server center and which are personalized in response to the requester's profile.

The data transmitted to the server center from these forms constitute a set of two-dimensional data establishing the relations among a multiplicity of requesters and a multiplicity of operators. This data set enables processing for combining (same environment as the request) or sharing (multiple environments) the resources by bringing together tasks which are close on a time-related or geographic level. To do this, each operator is identified by a profile determining its resources and the server center runs a resource employment file enabling optimization of the allocation of these resources.

The architecture of the invention brings together the constraints established by:

the final user which causes activation of the operating sequence and sets the parameters as well as the time and quantity variables. The final user is an issuer of the request;

the request issuer which locates itself at different levels of the logistics chain and sets parameters and variables specific to its environment and in relation to those specified by the final user;

the requester which is the proprietor of the request and sets the administrative management parameters of the system; and

the operators or effectors formed by the enterprises implementing one or more operations of the operating sequence.

The same actor can have multiple statuses.

The parameters taken into account by the system for defining the operating sequence are set by the final user, the issuers of requests and the requester. The parameters characterize for each operation the requirements at the level of the product state (regulation and standards, type of package and packing), means (vehicle type), and documentation (access, type of monitoring, documents). The central server comprises calculation means for verifying the coherence of these parameters.

The variables define the state of the parameters (type of regulation, type of packaging, business hours, volume to transport, security plan, etc.). They are taken into account by the system upon activation of the previously defined sequence.

The parameters are associated with the operating sequence during the definition phase. The set parameters correspond to a given operating sequence and give it its uniqueness.

Four steps can be distinguished in the operation of the invention, which are brought about in turn or simultaneously by different actors and/or operators: definition, activation, action and validation.

During the definition step, the operating sequence is drawn up on the basis of the request and the parameters provided by the various actors.

Following the triggering event, the variables linked to the instantaneous physical requirements are taken into account by the system during the activation step.

Each operation of the active sequence then gives rise to an execution order and information for the operators involved by the action on the physical flow during the action step.

Each component of an operation, specified in the established procedure, is recorded by the operator when it is implemented. As soon as the set of components of an operation has been executed, the operation is validated. Validation creates an information element available to the system actors.

Implementation of these steps involves the following interventions:

issuance of a request by a requester. The request must enable providing the databases of the server center with information on the actors of the specific logistical environment;

establishment of information relative to provisions. A request can concern one or more provisions. A provision groups together a set of operations that are performed by the server center to respond to an expectation of the final users;

definition of the operations. An operation is characterized by linking the components following a given procedure adapted to the implementation of a final requirement, for example, the operations of receiving, passing through customs, packaging, transport and documentation;

establishment of a triggering event constituted by a parameter set upon establishment of the operating sequence from the provision request. A triggering event activates the corresponding operating sequence;

triggering of warning signals in the case of action or information not conforming to the forecasts in terms of elapsed time, cost or means. These warning signals are transmitted to the operators;

access to the information conveyed by the information system and entered in memory by the server center; and

documentation of the operations in process.

After collecting the operations and parameters, the components of the operating sequence are drawn up by means of a procedure library providing the aid necessary such that the most suitable process corresponds to each parameter. The components that are drawn up are articulated and linked in a process to be implemented in the activation. The library includes a time base enabling definition of the execution time allocated to each component.

The calculation means of the server center establishes the critical path of the components in implementing the operations or components in concealed time to reduce execution time.

Upon activation of a sequence, the variables assigned to each component are recorded and the server center sets a theoretical execution time for each component from a reference library. The total execution time of an operation is the sum of the execution times of these components. By taking into account this total time, the system establishes a planning of the operations that were previously organized upon definition of the operating sequence.

Operations of the same nature can be grouped together.

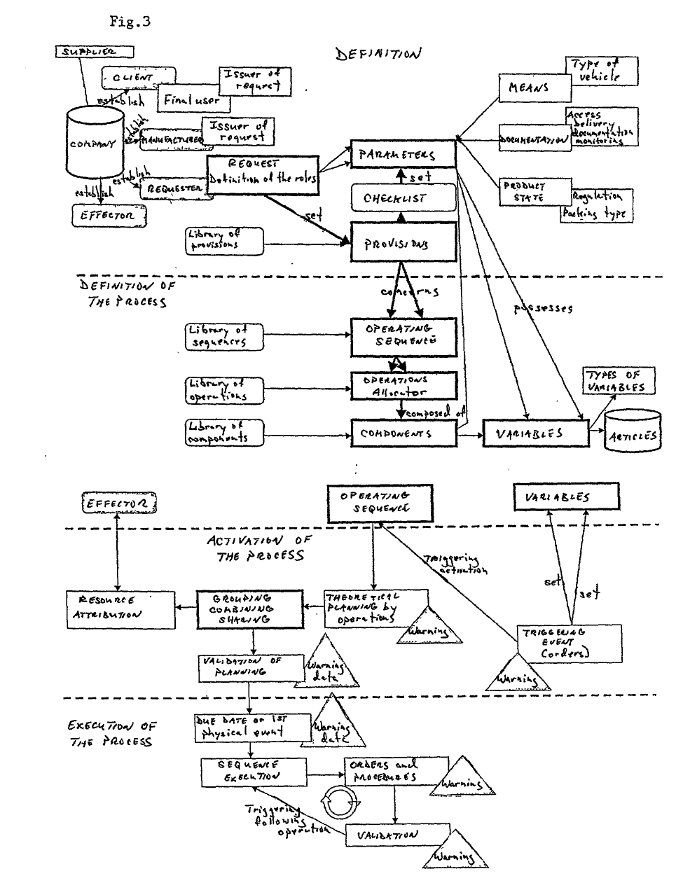

FIG. 3 represents a schematic view of the flow of data and information among the different components of the planning system according to the invention. The process according to the invention implements a combining and a sharing of resources.

The term “combining” means grouping together on the same site and at the same time operations of the same nature requested by different users.

The term “sharing” means grouping together on the same route (consecutive site-moments) of operations of the same nature requested by different users.

The process performs a periodic recalculation of the operating sequences in relation to the resource availability parameters and resource weighting factors, for example, in relation to the cost and quality of the resources.

The system optionally performs the evaluation of different resource-allocation options for calculating a performance index and selecting the optimal option and replanning the set of operations in relation to this optimal option.

The use of the Internet or more generally of a computer-controlled open network adds to this process the functions of combining and sharing of the resources among multiple enterprises. The development of these functions proceeds directly from the common use of open networks among multiple enterprises and implementation of direct relations of the resources with the requirements.

Organization of the flows between two entities via construction of an operating sequence enables, when this sequence is activated, two modes of optimization of the use of the resources (transport, packaging and the like).

Thus, when multiple sequences contain a transport operation employing an identical path on identical dates, or dates which are close according to the predefined time tolerance threshold, and involving compatible products, it is possibly to combine these operations according to the diagram shown in FIG. 3.

This method thus makes it possible to attain transport cost savings by grouping together transport operations stemming from different sequences. Combining is applicable to sequences whose transport operations have the following criteria:

identical departure dates (with a time tolerance threshold) and sites,

identical arrival dates (with a time tolerance threshold) and sites,

compatible product types, and

compatible transport types.

Allocation of the resources makes it possible to respond to the characteristics and requirements of the set of combined operations: weight/volume, transport type, date and elapsed time of implementation and the like.

The constructed combination scenarios are continuously evaluated with regard to the resource allocation criteria.

Sharing is a refinement of combining. In contrast to combining, this method makes it possible to optimize the transport among geographic points which are not identical.

Sharing is a particular case of combining in which the operations do not have exactly identical time-related and geographic characteristics (date and site of beginning and/or ending). It is the geographic proximity which makes it possible to share the resources (i.e., organization of rounds of trucks in an industrial zone).

Two prerequisites are necessary for sharing:

sharing zones have been defined, and

time-related transport tolerances have been included in the construction of the transport operations.

Sharing zone: The system contains a cartography of members. “Sharing zones” are defined in this cartography. A sharing zone is a set of actors for which a sharing of resources would be possible (i.e., within an industrial zone or on the same street).

The membership criteria for a given sharing zone are multiple and parameterizable: geographic proximity, membership in the same town, same city, same urban area and the like.

Zone of time-related tolerance: a time-related delta is associated with each geographic zone. This delta corresponds to the maximum acceptable time-related interval for sharing two operations which do not have the same start and end dates. This zone is defined by activity sector and is entirely parameterizable.

Parallel to the combining, the system constructs sharing scenarios with the sequences to be executed.

When the scenarios are constructed, they are evaluated, challenged, abandoned or recalculated continuously until a limit date prior to advancement into execution.

During this period, resource allocation allows filtration of the scenarios regarding the available resources. The system filters the following criteria: membership in the same sharing zone, operation of the same nature, partial covering of the dates comprised in the delta, availability and cost of the resource.

At the end of this period, resource reservation is begun: The available scenarios corresponding to the sequence are frozen. One scenario is then selected from among all the possible scenarios. The resource then assigned to this scenario is made unavailable.

The operations impacted by the combining or sharing are capable of being replanned in relation to the scenario selected.

Three possible types of sharing can be referenced:

from zone to zone,

round trip, and

on the path.

For the same type of transport resource, the sharing algorithm represented in FIG. 4 will endeavor, if it is possible, to group together two sequences having the same departure sharing zones and the same arrival sharing zones.

The two sequences will not be shared unless the transport means are the same and if:

A1 and A2 are members of the same sharing zone,

B1 and B2 are members of the same sharing zone,

the elapsed time of route A1 to A2, cumulated with the loading time of the second sequence, is less than the time-related tolerance delta, and

the elapsed time of route B1 to B2 cumulated with the loading time of the first sequence, is less than the time-related tolerance delta.

The loading time of the second sequence is found by determining the duration of the loading task in the operation preceding the transport operation.

The loading time of the first sequence is found by determining the duration of the loading task in the operation following the transport operation.

The algorithm obtained in this manner can be triggered again to verify whether it is possible to share another sequence by deducting the time already consumed by the association of the first sequence with the second sequence (route time, loading time, unloading time).

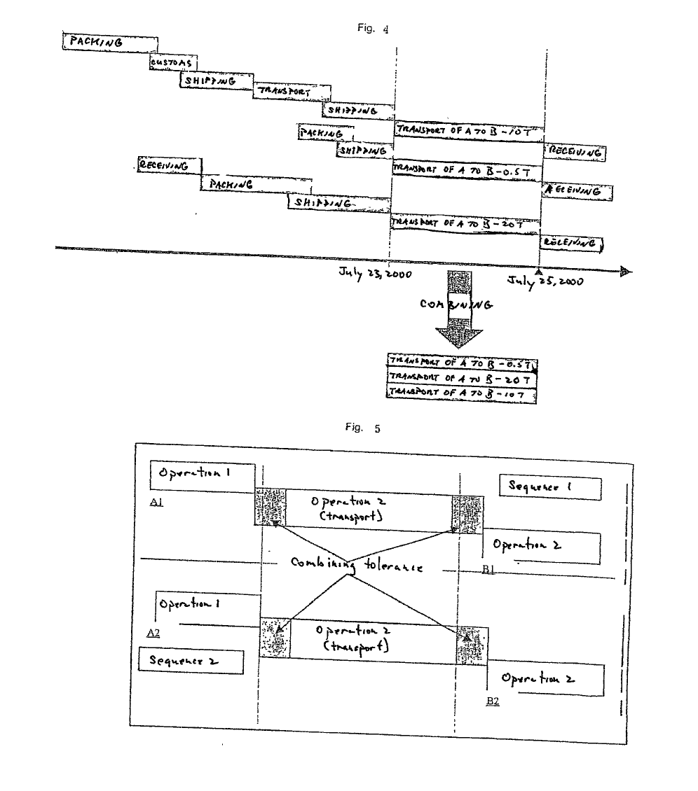

The sharing algorithm represented in FIG. 5 determines, for the same type of resource, whether it is possible to load in the same zone and unload in another zone for different activated sequences. This operation optimizes the transport means among all of these actors of different sequences.

The system only retains the sequences whose actors are in the same arrival and departure zone with the condition, nevertheless, that the time that has elapsed implementing the detours of the other actors does not exceed the tolerances of each of the grouped-together sequences. From the transit time among the actors of the same system, the system will take into account a loading time sum and an unloading time sum.

In the example above, the departure time of ‘Distributor 1’ transport increases the elapsed transport time between ‘Distributor 1’ and ‘Distributor 2’ and the loading time sum corresponds to the tolerance zone of transport from D2 to C2. The same is true for the transport between D2 and D3, as well as for unloading upon arrival at C1 then C2 and then C3.

In summary, (assuming that sharing brings together two sequences) it is necessary that:

the departure time of the truck from D1 augmented by the transit time between D1 and D2 augmented by the sum of the duration of loading corresponds to the time-related tolerance zone of the transport operation from D2 to C2;

the departure time from D2 augmented by the elapsed transport time between D2 and C1 corresponds to the transport tolerance zone of sequence 1; and

the arrival time at C1 augmented by the sum of the duration of unloading and augmented by the elapsed transport time between C1 and C2 corresponds to the time-related tolerance zone of the operation of the second sequence.

The loading duration sum and the unloading duration sum are values that can be parameterized by sector and by weight/volume of product handled.

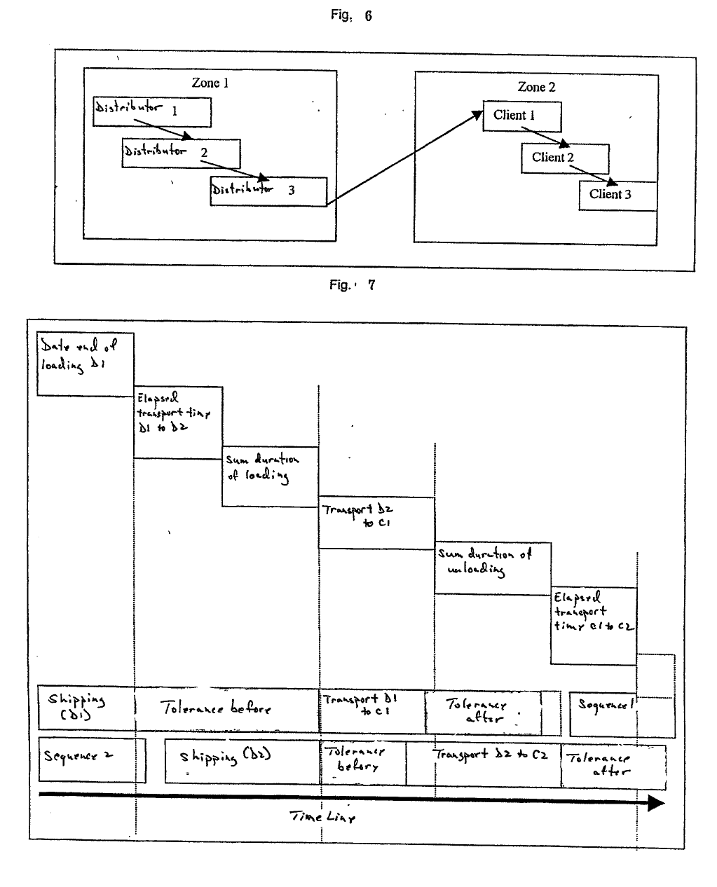

The example represented in FIG. 6 takes up two sequences with transports from D1 to C1 and from D2 to C2, respectively. Unloading D1 to C1 is performed in advance of phase in relation to the date/hour of the sequence. Otherwise, sequence 2 is violated and there is the risk of exceeding its tolerances.

The sharing algorithm represented in FIG. 7 determines, for the same type of transport resource, whether it is possible to group together two sequences the second part of which is in the sharing zone of the first.

The two sequences will only be shared if the transport means are the same and if:

B1 and A2 are members of the same sharing zone, and

the time required for route B1 to A2 cumulated with the loading time of the second sequence is less than the parameterized time-related tolerance.

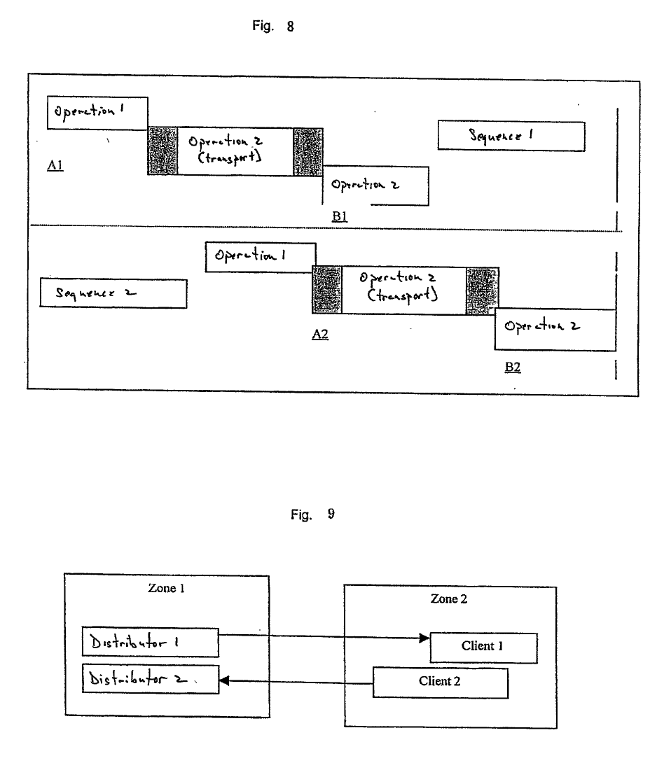

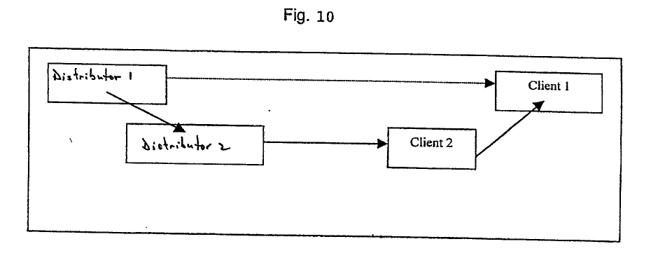

The system verifies whether it can use the same transport resource for performing the return of a route whose departure and arrival zones are inverted (FIG. 8).

The constraint on implementing this type of allocation is that the date of making available the first sequence added to the elapsed transport time between the actors of arrival of the first sequence and departure of the second sequence must correspond to the tolerance zone of the second sequence.

The sharing system on the path (FIG. 9) determines, in the path of one sequence, whether it is possible to add the path of another sequence.

This can only be implemented if:

the detour time for performing the loading of the second sequence augmented by the loading duration sum must be in the tolerance period of the second sequence, and

the route time of the second sequence augmented by the unloading duration sum augmented by the elapsed time of the detour path of the second sequence to return to the final actor of the second sequence is in the tolerance period off the shared transport operation in the first sequence.

In a preferred embodiment, the variables assigned to each component are recorded during activation of a sequence and the server center sets a theoretical execution time for each component and establishes a planning of the operations that were previously organized upon definition of the operating sequence.

In another preferred embodiment, the process further includes preparing a library of solutions recorded by the server center, with data stored in the library being used during the establishment of the definitions of the operations.

In still another preferred embodiment, the parameters taken into account when defining the operating sequence are set by a final user and associated with the operating sequence in a manner such that set parameters correspond to a selected operating sequence.

In yet another preferred embodiment, the process further forms an operations library in a database of the server center by linking components following a selected procedure adapted to implementation of a final requirement.

In a further preferred embodiment, the process further generates a warning/triggering signal when action or information not conforming to forecasts in terms of elapsed time, cost or means is present and transmits the warning signals to operators.

In a still further preferred embodiment, the process further groups together operations of similar nature established in different operating sequences.

1. Computerized or computerizable process for planning logistical operations, characterized in that it comprises:
a step of constituting a companies database comprising a multiplicity of information files descriptive of the profile of each intervener, this information comprising in particular an identifier and a list of the usual destinations of the environment considered, said “companies” database being stored in a memory of a server center,
a step of establishing by means of the calculator of the server center of an “operations definitions” file in response to a request from a requester registered in the “requesters” database,
a step of transmitting by the server center, for each operation defined in the preceding step, of a definition file of the operation parameters comprising a form for determination of the nature and specificities of the operation, and definition of at least one actor of the operation,
steps of definition and updating of the operating sequence by the server center, this step consisting of calculating from the information transmitted during the preceding steps of a definition file of the nature and chronology of the operations, and
a step of activation of the operating sequence by a triggering event and an operation of testing the conformity of the triggering event with the operating sequence.

2. Computerized or computerizable process for planning logistical operations according to claim 1, characterized in that the variables assigned to each component are recorded during the activation of a sequence and in that the server center sets a theoretical execution time for each component and establishes a planning of the operations that were previously organized upon definition of the operating sequence.

3. Computerized or computerizable process for planning logistical operations according to claim 1, characterized in that it comprises a step of preparation of a library of solutions recorded by the server center, with the data stored in this library being exploited during the steps of establishing the definitions of the operations.

4. Computerized or computerizable process for planning logistical operations according to claim 1, characterized in that the parameters taken into account by the system for defining the operating sequence are set by the final user and associated with the operating sequence during the definition phase in a manner such that the set parameters correspond to a given operating sequence which give it its uniqueness.

5. Computerized or computerizable process for planning logistical operations according to claim 1, characterized in that an operations library is recorded in a database of the server center, which library is characterized by the chaining of the components following a given procedure adapted to the implementation of a final requirement.

6. Computerized or computerizable process for planning logistical operations according to claim 1, characterized in that it comprises warning triggering operations in the case of action or information not conforming to the forecasts in terms of elapsed time, cost or means and transmission of these warning signals to the operators.

7. Computerized or computerizable process for planning logistical operations according to claim 1, characterized in that operations of the same nature established in different operating sequences are grouped together.

8. A computerized or computerizable process for planning logistical operations, comprising:
a) forming a companies database comprising a multiplicity of information files descriptive of a profile of selected interveners, the information files comprising an identifier and a list of usual destinations of an environment considered, said companies database being stored in a memory of a server center,
b) establishing with a calculator of the server center an operations definitions file in response to a request from a requester registered in a requesters database,
c) transmitting by the server center, for each operation defined in steps a) and b), a definition file of operation parameters comprising a form for determining the nature and specificities of the operation, and defining at least one actor for each operation,
d) defining and updating an operating sequence by the server center from information transmitted during steps a)-c), and
e) activating the operating sequence with a triggering event and testing conformity of the triggering event with the operating sequence.

9. The process for according to claim 1, wherein variables assigned to each component are recorded during activation of a sequence and the server center sets a theoretical execution time for each component and establishes a planning of the operations that were previously organized upon definition of the operating sequence.

10. The process according to claim 1, further comprising preparing a library of solutions recorded by the server center, with data stored in the library being used during step c).

11. The process according to claim 2, further comprising preparing a library of solutions recorded by the server center, with data stored in the library being used during step c).

12. The process according to claim 1, wherein parameters taken into account when defining the operating sequence are set by a final user and associated with the operating sequence in a manner such that set parameters correspond to a selected operating sequence.

13. The process according to claim 2, wherein parameters taken into account when defining the operating sequence are set by a final user and associated with the operating sequence in a manner such that set parameters correspond to a selected operating sequence.

14. The process according to claim 3, wherein parameters taken into account when defining the operating sequence are set by a final user and associated with the operating sequence in a manner such that set parameters correspond to a selected operating sequence.

15. The process according to claim 1, further comprising forming an operations library in a database of the server center by linking components following a selected procedure adapted to implementation of a final requirement.

16. The process according to claim 1, further comprising generating a warning/triggering signal when action or information not conforming to forecasts in terms of elapsed time, cost or means is present and transmitting the warning signals to operators.

17. The process according to claim 1, further comprising grouping together operations of similar nature established in different operating sequences.
